(19) United States
(12) Patent Application Publication
(10) Pub. No.: US 2026/0302171 A1
(43) Pub. Date: Oct. 1, 2026

(54) MATERIALS AND METHODS FOR HIGH ENERGY DENSITY SILICON LITHIUM ION BATTERIES

(71) Applicant: UNIVERSITY OF LOUISVILLE RESEARCH FOUNDATION, INC., Louisville, KY (US)

(72) Inventors: Rachel DEWEES, Louisville, KY (US); Mahendra SUNKARA, Louisville, KY (US)

(73) Assignee: UNIVERSITY OF LOUISVILLE RESEARCH FOUNDATION, INC., Louisville, KY (US)

(21) Appl. No.: 19/480,806

(22) PCT Filed: May 28, 2024
(86) PCT No.: PCT/US2024/031223

§ 371 Date: Nov. 1, 2025

Related U.S. Application Data
(60) Provisional application No. 63/504,733, filed on May 27, 2023.

(51) Int. Cl. H01M 4/134; H01M 4/02; H01M 4/04; H01M 4/1395; H01M 4/38; H01M 4/66; H01M 10/0525

(52) U.S. Cl. CPC H01M 4/134; H01M 4/0404; H01M 4/0428; H01M 4/1395; H01M 4/386; H01M 4/661; H01M 10/0525; H01M 2004/021; H01M 2004/027

(57) ABSTRACT

A silicon anode material has silicon tubes bonded directly to a copper current collector. The material may be made by casting a sacrificial substrate on copper foil; depositing silicon on the sacrificial substrate and copper foil; and removing the sacrificial substrate such that silicon nanotubes remain which are bonded directly to the copper foil. The nanotubes may be amorphous silicon. A lithium ion battery includes a layer of interconnected thin-walled silicon tubes. The porous nature of the layer as well as the open core of individual tubes provide space for the silicon to expand without pulverizing upon cycling.

### CROSS-REFERENCE TO RELATED APPLICATIONS

This application claims the benefit of U.S. provisional patent application No. 63/504,733, filed May 27, 2023, the complete contents of which are herein incorporated by reference.

### STATEMENT REGARDING FEDERALLY SPONSORED RESEARCH OR DEVELOPMENT

This invention was made with government support under Grant Nos. GB210924 and GB230244 awarded by NASA Kentucky. The government has certain rights in the invention.

### FIELD OF THE INVENTION

This disclosure generally relates to lithium ion batteries and, in particular, methods of making anode materials and resultant batteries which incorporate silicon in the active material.

### BACKGROUND

The motivation for lithium-ion battery development is evident environmentally and economically, on a global scale. The EPA has determined that more than a quarter of greenhouse gases are being produced by the transportation sector. The transportation sector produces more than 1 billion metric tons of CO₂ annually. Sales of combustion engine vehicles peaked in 2017, and the decline is expected to be permanent. The EV market, on the other hand, is shifting from one driven by policy to one where demand is the most important factor. While carbon emissions from transportation will not be eliminated in the short term, current trends suggest that half of projected emissions can be avoided by the growth of the EV market. The EV market would not be possible without lithium-ion batteries. The development of lightweight, long-lasting Li-ion batteries is of great technological importance for activities which are critical to the continued survival and progress of humanity; including but not limited to automotive, aerospace, and power grid applications.

Since their inception, lithium-ion batteries have become increasingly optimized. Lithium-ion batteries are expected to fit inside many size/weight constrained devices (e.g., from handheld mobile phones to electric vehicles) and operate under near continuous use for months, years, or even decades. To satisfy such design goals, the combinations of materials employed in the batteries must be susceptible not merely to storing large amounts of energy in relatively small cells, but to maintaining acceptable storage capacities over many cycles of charging and discharging. Massive ongoing global fundamental and applied research effort is currently underway to increase energy density and cycle life. Increasing the specific capacity of the electrode materials is the most direct strategy for increasing the energy density of the battery.

Present lithium-ion battery development includes carbon anode material (graphite being the most common with a practical specific capacity of 372 mAh/g) and active cathode material such as LiCoO₂ (LCO) which has a practical specific capacity of 142 mAh/g.

Silicon is viewed as a promising material for a high-capacity anode that some in the industry hope to take the place of commercialized graphitic anodes for lithium-ion batteries. Silicon is earth abundant, non-toxic, operates at a low discharge potential, and has a theoretical capacity of ~3700-4200 mAh·g⁻¹. However, silicon incorporates lithium into its microstructure as an alloying process as opposed to direct intercalation, the process by which graphite is lithiated. As such, unlike graphite, silicon undergoes a volume change of many magnitudes (e.g., 300%) during alloying with lithium which can cause mechanical degradation during cycling. Many silicon structures can be pulverized as the silicon particles are quickly lithiated. Under these circumstances, the battery industry has struggled to develop silicon anodes exhibiting acceptable cycle life.

Besides the issue of mechanical degradation from use, silicon anodes also present unique difficulties at the fabrication stage. Three major challenges plague silicon nanowire fabrication and use for lithium-ion batteries. First, the use of high temperatures during the chemical vapor deposition process (e.g., 700-800° C.)—necessary when using transition metal catalysts—is prohibitive. Second, the amount of silicon that can be grown per geometrical area of metal substrate is limited. The third challenge involves the anodic current collector. Copper is widely considered an exemplary material for the current collector of a Li ion battery anode, and copper current collectors are common among existing graphite anodes. However, the use of copper as a substrate for silicon deposition has generally proven impossible. The majority of vapor-liquid-solid (VLS) methods only allow the use of thick metallic substrates such as nickel or steel due to the high temperatures and result in low loading (mg/cm²). Poor adhesion of silicon to any of these metal substrates and insufficient control of silicon nanowire cycling behavior are problems for which satisfactory solutions have not been found.

The first silicon on copper foil anode work published in 2012 consisted of a process of growing a silicon thick film by electron cyclotron resonance-chemical vapor deposition (ECR-CVD) then subsequent etching to produce unidirectional silicon nanorods (Nguyen Si Hieu a, J. C. L. a., Joong Kee Lee, Free-standing silicon nanorods on copper foil as anode for lithium-ion batteries. Microelectronic Engineering, 2012. 89: p. 138-140). Any liquid etchant, however, will attack the interface and cause delamination of active material from the copper current collector.

No solution has yet been discovered to bond silicon, especially pure silicon, to copper such that the resulting material demonstrates the practical functionality required in commercial Li-ion batteries.

### SUMMARY

An objective achieved by some embodiments is creation of a silicon anode active material (up to 100% silicon) for lithium ion (Li-ion) batteries.

An objective achieved by some embodiments is the building of a high energy density lithium-ion battery containing a (up to 100%) silicon anode active material for Li-ion batteries.

An objective achieved by some embodiments is a silicon anode material comprising silicon bonded directly to a copper current collector.

An objective achieved by some embodiments is the synthesis of silicon anode material composed of or comprising amorphous silicon tubes bonded directly to a copper current collector.

In some embodiments, methods deposit a silicon nanotube layer bonded directly to a copper film, all in one streamlined process. The resulting material has novel morphology and is a functional anode. Characterization results show that an exemplary process creates proper nanostructure and morphology, crystal structure, and chemical composition. Electrochemical results show that high capacity is achieved.

Some embodiments comprise silicon-copper foil battery grade anode material. The specific capacity may be, e.g., up to at least 10× that of current state-of-the-art graphite material. Advantages include less weight, more energy storage, and long milage capability between charges. Increasing the specific capacity of the Li-ion battery anode is an elegant way to reduce battery weight, volume, and cost. Silicon-based anode materials have a theoretical capacity of over 4200 mAh/g⁻¹, an order of magnitude beyond that of the graphitic materials which are currently implemented.

Some exemplary embodiments employ nanosizing to mitigate detrimental effects of the volume change of silicon during lithiation and delithiation. Nanosizing is a technique which increases the available surface area of a material. Exemplary embodiments engineer porosity within the silicon structure to provide necessary space for volumetric expansion to occur without damaging the anode. A combination of nanosizing and incorporation of sufficient porosity brings embodiments of the present disclosure closer to the full theoretical capacity of silicon available for energy storage.

Some embodiments include an anode material comprising a layer of thin-walled interconnected silicon tubes. A porous nature of the layer allows silicon to expand without pulverizing upon cycling. The volumetric growth is accommodated both in the hollow interiors of respective tubes and in the spaces between neighboring tubes. In some embodiments, a solid electrolyte interface (SEI) layer may develop on both inner walls and outer walls of silicon tubes upon cycling.

Exemplary as-fabricated anode materials can withstand substantial volume changes of cycling without significant degradation, e.g., volume changes up to 400%. The silicon nanotubes incorporate lithium into their microstructure as an alloying process as opposed to direct intercalation, like graphite; as such, exemplary anode materials may give allowance for a volume change of, e.g., ~300%.

Exemplary anode materials comprising or consisting of a layer/film of silicon nanotubes may have Si loading of e.g. at least 1.2 mg·cm⁻².

In exemplary anode materials, the percentage of the active material which is silicon may be as high as 100%. Depending on the embodiment, however, the percentage of the active material which is silicon may be at least as high as 20%, 30%, 40%, 50%, 60%, 70%, 80%, 90%, 95%, 96%, 97%, 98%, or 99%.

Exemplary anode layer/film thicknesses include but are not limited to 5-30 μm. Exemplary anode layer/film thicknesses may be at least 10 μm, or at least 15 μm, or at least 20 μm, or more than 20 μm.

Increasing silicon loading of anode material by increasing the tube wall thickness effectively increases areal capacity. Exemplary areal capacities for some embodiments are, for example, at least 2.0 mAh·cm⁻² over 50 cycles at reasonable loading.

Exemplary (unlithiated) nanotube wall thicknesses include but are not limited to sizes up to 200 nm, for example. Exemplary minimum wall thickness may be, for example, 1 nm or 5 nm. Exemplary silicon nanotubes may have an average wall thickness of 5-200 nm without lithiation. Exemplary average wall thickness may be limited in some embodiments to a maximum of, for example, 150 nm.

Exemplary silicon nanotube lengths may be, for example, 0.2-4 μm.

Some embodiments may dope the silicon nanotubes with one or more dopants such as but not limited to boron. This may be performed to increase conductivity, for example.

Some embodiments may coat the silicon nanotubes with one or more materials such as but not limited to carbon.

Some embodiments may employ interface layers, whereas other embodiments may not employ interface layers.

In some exemplary embodiments, an anode material is configured to have isotropic expansion. In particular, in an anode material with silicon nanotubes, the silicon nanotubes are configured to exhibit isotropic expansion during lithiation.

In some exemplary embodiments, silicon pulverization during lithiation is further minimized by controlling at the time of material synthesis the phase or phases of silicon which form and remain. In some exemplary embodiments, silicon nanotubes comprise amorphous state silicon as one exemplary means of achieving appropriate forms of isotropic expansion during lithiation of the anode. Of the silicon present in an anode, the percentage which is amorphous may vary among embodiments. For instance, the amount of silicon which is amorphous state (e.g., at least at the time of manufacture) may be at least 30% or essentially 100%. An amorphous silicon nanotube, configured with appropriate size parameters, can expand and contract without pulverization or complete loss of electrical contact. Lithiation causes elastic softening of silicon. Amorphous silicon is more ductile than crystalline silicon, and the ductility of silicon in either state increases as lithiation proceeds.

In some embodiments, some of the silicon may be deliberately produced as phases other than amorphous. Exemplary processes may produce a layer comprising one or more amorphous silicon, crystalline silicon, or mixed character silicon. The active material layer may comprise nanotubes of one or more such different phases directly bonded to a copper current collector. The parameters used during silicon deposition (e.g., by PECVD) may be adjusted to produce either amorphous, crystalline, or mixed character silicon nanotubes.

Some exemplary processes for synthesizing a silicon anode material may place strict control on process parameters such as but not limited to temperature, pressure, and deposition rate. For example, some exemplary processes may deposit silicon (e.g., by PECVD) at temperature(s) not exceeding 500° C. Some exemplary processes may be implemented such that all process steps do not involve temperatures exceeding 350° C. The pressure at which the silicon deposition step is performed may be limited to be within 0.2 T-1.5 T. In particular, a step of silicon deposition may be controlled so that pressure used during the deposition is around 1 T.

Relatively low temperature and high pressure processes for forming a silicon anode material are unusual in the industry but have one or more important impacts for exemplary embodiments of this disclosure. One important implication is control of the phase of the silicon which is deposited. Another important implication is control over (e.g., preventing or limiting) the formation of copper silicide (CuₓSi_{y}). Silicon deposition by PECVD exhibits evolution from amorphous to crystalline character based upon deposition pressure. Amorphous silicon deposition may be maximized at a pressure closer to 1 T, for instance, whereas decreasing pressure forms an increasingly crystalline silicon layer.

In lithium-ion battery anodes, copper silicide behaves as an inactive material. In other words, copper silicide does not actively participate in the lithiation and delithiation processes. It remains largely inert and stable. In some embodiments, process conditions are selected so as to minimize copper silicide formation for a few different reasons. First, the formation of copper silicide diverts silicon into an inactive material that would otherwise contribute to active material. As many battery applications place a high value on battery size and weight minimization, excessive inactive material negatively impacts battery size, weight, and capacity (mAh·g⁻¹). Furthermore, significant copper silicide poorly positioned relative to active silicon material can physically impair or prevent desirable volumetric expansion of the active silicon during lithiation and, at the worst, constrain the active silicon such that it pulverizes when lithiated. Exemplary embodiments may employ process conditions during at least the step of silicon deposition to minimize or eliminate the possibility of copper silicide formation.

The foregoing being said, some embodiments may deliberately allow for inclusion of some copper silicide, the amount and arrangement of which being carefully controlled to leverage desirable qualities of the inactive material. For example, limited copper silicide may be formed to provide structural support to the active material layer and/or to assist in maintaining electrical conductivity with the current collector. For example, according to an exemplary process, process parameters may be selected so that copper silicide formation may be substantially non-existent during silicon deposition. However, after the silicon deposition is completed, a copper-silicide interface (of anode and current collector) may be formed by a further step of heat treatment which employs relatively high temperatures (e.g., greater than 500° C.) to form a copper-silicide interface with negligible formation of copper-silicide on the silicon nanotubes. Exemplary silicon anode materials may comprise no more than, e.g., 10% copper silicide by mass.

An exemplary method of synthesizing an exemplary silicon anode material may include such steps as casting a sacrificial substrate (e.g., ZnO) on copper foil, depositing silicon on the sacrificial substrate and copper foil (e.g., by Plasma-Enhanced Chemical Vapor Deposition (PECVD), and removing the sacrificial substrate such that a silicon layer remains which is bonded directly to the copper foil. The growth of the silicon anode directly onto copper which serves as the current collector once incorporated into a complete battery assembly has the benefit that exemplary methods of anode and battery production can exclude any post-anode-production step of attaching anode and current collector (e.g., by the use of a binder). The formation of the anode material layer and the connection/bonding of such anode material to a current collector occur simultaneously in exemplary processes according to this disclosure.

### BRIEF DESCRIPTION OF THE DRAWINGS

FIG. 1 is a schematic of an exemplary Li-ion battery and related electronics.

FIG. 2 is a diagram of an exemplary process for making a silicon-on-copper anode material.

FIGS. 3A-3E show various exemplary silicon nanotubes.

FIGS. 4A and 4B are sample scanning electron microscopy (SEM) images of silicon anode materials that comprise silicon (Si) nanotubes bonded directly to copper (Cu) current collectors.

FIG. 5A is an SEM image of an exemplary silicon anode material consisting of silicon nanotubes bonded to copper current collector.

FIG. 5B is a variant of the SEM image of FIG. 5A in which only silicon is visible.

FIG. 5C is another variant of the SEM image of FIG. 5A in which only copper is visible.

FIG. 6 is an SEM image of a further exemplary silicon anode material consisting of silicon nanotubes bonded to copper current collector.

FIG. 7 shows elemental analysis data for the material imaged in FIG. 6.

FIG. 8A shows X-ray diffraction (XRD) scans which show the presence of pristine copper foil, nc-Si formation, and a Cu₃Si layer for a sample material empirically tested in an Example.

FIG. 8B is an enlarged view of the nc-Si peaks from FIG. 8A.

FIG. 8C is raman data from the Example which confirms formation of a-Si, c-Si, and mixed character samples as deposition pressure varied in an empirical test scenario.

FIG. 8D shows data from the Example which shows % c-Si decreases as pressure increases.

FIG. 9A shows results of cycle performance of anodes loaded with 0.3 mg/cm² silicon, with tubes at wall thicknesses of 5-20 nm.

FIG. 9B shows charge discharge curves for cycle performance of a sample material.

FIG. 9C shows anodes at 0.6 mg/cm² silicon loading with nanotube wall thickness of 50-75, 100-150, and 150-185 nm maintained capacity up to 1000 mAh·g⁻¹ at 35 cycles.

### DETAILED DESCRIPTION

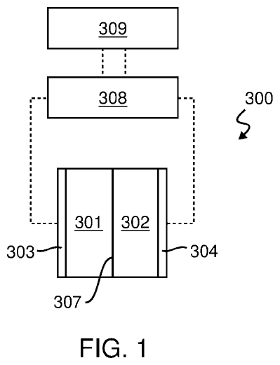

FIG. 1 depicts schematically a lithium-ion battery 300, comprising an anode 301 and cathode 302. In general, an exemplary lithium-ion battery 300 further includes current collectors 303 and 304 for the anode 301 and cathode 302, respectively. The anode 301 and cathode 302 may be separated by a separator 307 which is permeable to lithium ions. The battery 300 may further comprise one or more electrolytes. A battery 300 may further include, or else be electrically connected with, control circuitry 308. The control circuitry 308 may be manufactured so as to be inseparable from the chemical cells, for instance. Alternatively, the control circuitry 308 may belong to one or more external circuit arrangements such as a motherboard. The control circuitry 308 may be or include one or more microprocessors, one or more processors, and/or like controlling devices. The control circuitry 308 may be configured to regulate charging and discharging (collectively cycling) of the battery. The battery 300 may be discharged to power one or more loads 309.

An exemplary battery 300 may comprise a silicon (Si) anode 301. More specifically, the anode 301 may comprise a layer of silicon nanotubes bonded directly to a copper foil current collector 303. The cathode 302 may comprise but is not limited to lithium nickel manganese cobalt oxide (lithiated NMC). The silicon nanotubes may have an amorphous state. The amorphous silicon tubes may have Si loading of, e.g., at least 1.2 mg·cm⁻².

The control circuitry 308 may be configured to regulate charging and enforce a maximum charge limit to the battery which correlates with a maximum state of lithiation of the silicon nanotubes and, correspondingly, the maximum lithiated volume of the silicon anode. The control circuitry 308 may be configured to prevent lithiation of the silicon anode beyond a predetermined limit of volumetric expansion. The predetermined limit of volumetric expansion may be a safety limit above which mechanical degradation such as pulverization of the silicon nanostructures becomes an unacceptable risk. The limit may be determined based on anode parameters such as one or more of silicon loading of the anode, porosity of the silicon layer, tube wall thickness of the silicon nanotubes when maximally delithiated (i.e., when the battery is at maximum discharge/minimum charge), and others.

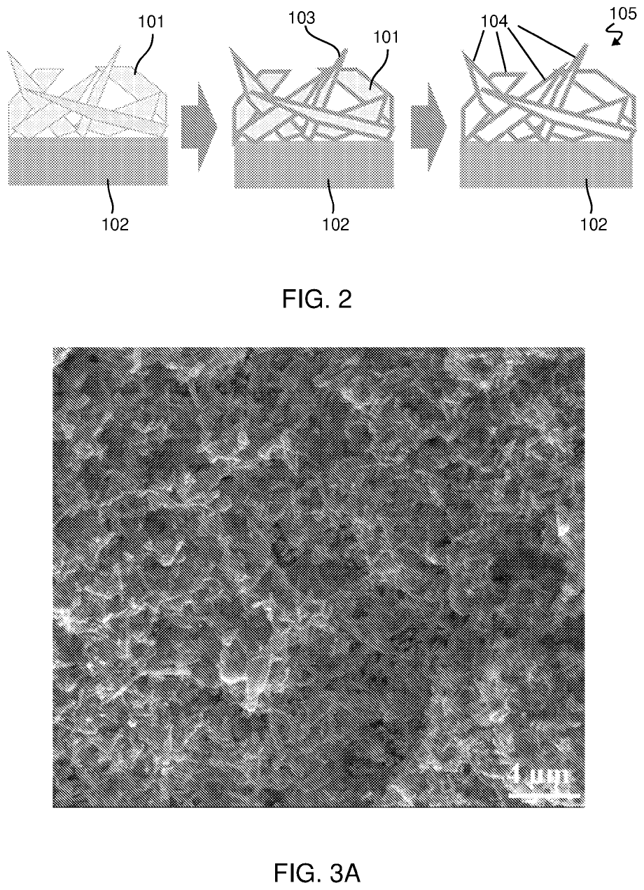

FIG. 2 depicts a method of synthesizing an exemplary silicon anode material. A sacrificial substrate 101 is cast on copper foil 102. The sacrificial substrate 101 may be cast to form a film of nanostructures having, for example, a nanowire and/or nanorod morphology. An exemplary sacrificial substrate is zinc oxide (ZnO). An alternative sacrificial substrate which may be used in some embodiments is silicon oxide, for example. Then silicon 103 is deposited on the sacrificial substrate 101 and copper foil 102. Then the sacrificial substrate 103 is removed such that silicon nanotubes 104 remain which are bonded directly to the copper foil 102. The process of making nanotubes using sacrificial templates results in a better size control of the resulting materials compared to alternatives such as supercritical hydrothermal synthesis. The silicon deposition may be made by, e.g., Plasma-Enhanced Chemical Vapor Deposition (PECVD). Tube wall thickness may be controlled by adjusting the deposition time. The deposition stage may be maintained at temperatures not exceeding 500° C. to minimize or eliminate the formation of copper silicide. The removal of the sacrificial substrate may be facilitated by switching gases, e.g., from hydrogen gas to HCl vapor. The step of removing the sacrificial substrate is performed without liquid etchants. There is no need for an annealing step or the use of any conductive binder. In some embodiments, however, the removal of the sacrificial substrate may be followed by a heat treatment at a temperature in excess of 500° C. to produce a layer of copper silicide formed at the interface between the layer of silicon nanotubes and the foil.

To create a desired amorphous structure, the temperatures of material synthesis may be kept relatively low. In some embodiments, temperatures should not exceed 500° C. In some embodiments, the temperature used for silicon deposition should not exceed 500° C. In some embodiments, the temperature used for sacrificial substrate removal should also not exceed 600° C.

Following is a non-limiting example of an exemplary method of synthesizing an exemplary anode material which conforms with the more general characterization of the preceding paragraphs. ZnO nanowire substrate is directly cast on copper foils and kept at temperatures less than 500° C. A dilute mixture of silane in hydrogen gas (2% SiH₄/H₂) at low pressure (<1 T) is subjected to plasma excitation with <100 W of RF power, which dissociates the silane to make Si:H and Si available to deposit on the substrate. After the silicon layer is able to grow to a desired thickness, the ZnO cores are removed in-situ using HCl vapor, leaving behind pure silicon tubes well bonded to the copper current collector. When subjected to a heat treatment after silicon deposition, a layer of copper silicide forms at the interface between the layer of tubes and the foil.

For a PECVD deposition, the deposition rate and distribution of radicals available in the plasma both impact the quality of the deposition. The electron temperature is determined under the assumption of the electron distribution function according to Maxwellian behavior, which is dependent upon electrode distance, pressure, and power. Radio frequencies excite 32 total radicals from silane gas; using the parameters to select for the most desirable radicals is a key to controlling silane deposition. Dilution of silane with molecular hydrogen reduces the production of higher silanes and increases the growth rate of amorphous hydrogenated silicon, which increases contribution of silylyl to film growth.

An exemplary output of the process depicted by FIG. 2 is a silicon anode material 105 comprising silicon tubes 104 bonded directly to a copper current collector 102. The silicon nanotubes may have an amorphous state. The silicon nanotubes may be configured to have isotropic expansion. An amorphous silicon state is one example way to achieve isotropic expansion. Amorphous silicon tubes may have Si loading of, e.g., at least 1.2 mg·cm⁻². The material 105 may be used as the anode in an exemplary lithium-ion battery.

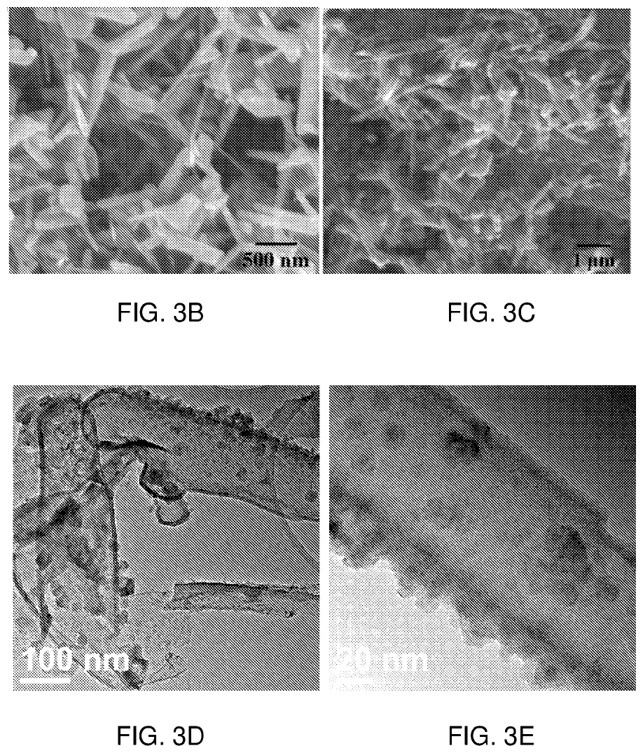

The silicon nanostructures of an exemplary anode material are collectively arranged in a layer/film of interconnected nanotubes. The layer/film is porous and permeable to battery electrolyte in an assembled battery. The sacrificial substrate and parameters selected for its casting on the copper current collector may be selected to influence the particular end product network structure of the interconnected silicon nanotubes. Most nanotubes have generally tubular geometries, but as the SEM images of this disclosure will convey (see, e.g., FIGS. 3A-3E), irregularities naturally exist among nanotubes from methods such as that of FIG. 2.

Nanotubes may or may not have open ends, depending on the embodiment. In some embodiments few if any nanotubes in an anode have open ends. Alternatively, in some other embodiments, a majority of nanotubes in an anode may have at least one opening (e.g., at an end). As a result, in a complete battery, electrolyte may be able to move into or out of the center hollows of nanotubes. The formation of a uniform thin solid electrolyte layer both inside and outside of the tubular structures can lead to an enhanced lifetime in terms of cycling.

Some embodiments may involve synthesis of silicon nanotube anode with stable Si—Cu interface with an effective ZnO removal step. Some embodiments may involve synthesis of amorphous silicon nanotubes. Silicon loading may be increased by increasing tube wall thickness of amorphous Si tubes and/or by increasing silicon nanotube layer thickness.

The mechanics of nanoscale silicon plays a role in battery performance. Whether nanoscale silicon has an amorphous or crystalline character has one of the greatest impacts on ductility of the nanoscale silicon. As structures become very small, it is useful to separate the stress into the surface stress and the bulk stress. In a case with such high surface area, behavior of materials will be dominated by surface properties. The hybrid model defines effective elastic modulus (E_{eff}) as the sum of the known elastic modulus (E₀) of the material and a factor including some surface modulus (Eₛ) estimate and wall thickness (t) of the tube:

$${E}_{eff} = {E}_{0} + [ ( \frac{{E}_{s}}{t} ) ] .$$

Generally, estimates of surface modulus project a softening of the silicon as the surface area is increased. Using a range of values, possible effective Young's modulus were calculated for max and min surface modulus, max and min tube wall thickness, and crystalline versus amorphous modulus of silicon. The results are given in Table 1, where Si_{c} represents crystalline silicon and Siₐ represents amorphous silicon.

TABLE 1
Effective elastic modulus of silicon in different conditions

| | |
|---|---|
| Si_{c} | Siₐ |

| | 5 nm | 150 nm | 5 nm | 150 nm |
|---|---|---|---|---|
| min Eₛ | 126.00 | 129.87 | 76.00 | 79.87 |
| max Eₛ | 130.02 | 129.85 | 80.02 | 79.85 |

Lithiation causes elastic softening of silicon. Amorphous silicon has a lower modulus than crystalline silicon when both are unlithiated, and both amorphous and crystalline silicon become more ductile as fraction of lithium x is increased. The following equations summarize the Young's modulus of crystalline silicon and amorphous silicon per dependency on fraction of lithium x:

$${E}_{c} = \frac{37.96 x + 156.13}{1 + x} {E}_{a} = \frac{18.90 x + 90.13}{1 + x}$$

The amorphous vs. crystalline character of the silicon is a driver of the strength of nanoscale silicon.

FIGS. 3A-3C are SEM images of example silicon nanotubes of different tube wall thicknesses. In some embodiments, amorphous silicon is a preferred morphology for at least some (up to essentially all) the nanotubes because expansion is isotropic and because it is a more ductile material.

FIG. 3A is a scanning electron microscopy (SEM) image of a layer of interconnected silicon nanotubes which were directly bonded to a copper current collector. FIGS. 3B and 3C are further SEM images of other anode materials each consisting of a layer/film of silicon nanotubes which were directly bonded to a copper current collector. Nanotubes may be produced with different qualities, e.g., thinner or thicker walls or collectively forming layers/films of different thicknesses from one embodiment to another embodiment. In general, nanotubes with thicker walls tend to have increased initial specific capacity but decreased capacity retention. Some non-limiting examples of nanotube wall thicknesses which may be used in various embodiments include 5-25 nm, 25-50 nm, 50-75 nm, 75-100 nm, 100-150 nm, and 150-185 nm. Morphologies of (active) anode material may vary among embodiments. As one non-limiting example, an anode material may comprise or consist of clusters of tubes that are interconnected for a network of anode material which loses minimal electronic connectivity through cycling. FIGS. 3D and 3E show transmission electron microscopy (TEM) images of silicon nanotubes which confirm the presence of hollows within the structures.

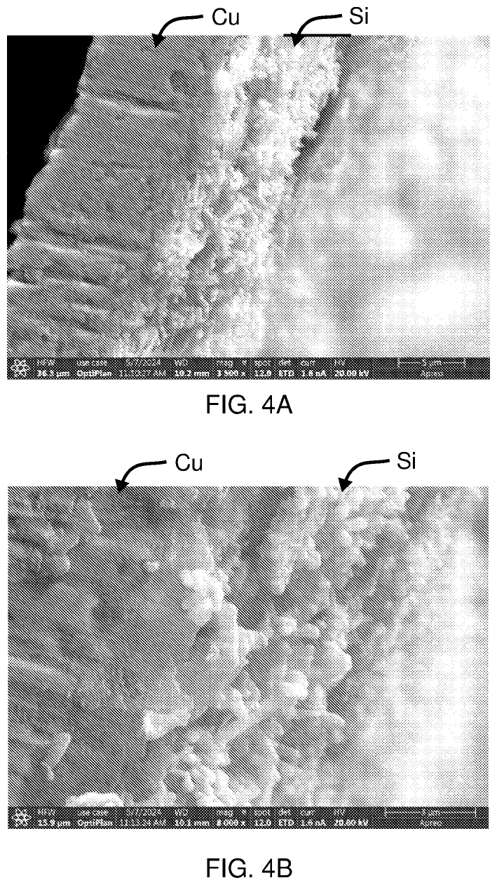

FIGS. 4A and 4B are sample SEM images of silicon anode materials that comprise silicon (Si) nanotubes bonded directly to copper (Cu) current collectors. The images show the silicon tubes are bonded directly to the copper foils. The interface between silicon and copper is a stable interface. An exemplary silicon anode material is susceptible to many (e.g., hundreds, thousands, tens of thousands, hundreds of thousands, or more) cycles without substantial loss of physical and electrical connection between the silicon tubes and copper current collector. In these and other exemplary embodiments of the disclosure, the silicon anode material is binder free. Exemplary processes of synthesizing such silicon anode materials do not use any binders.

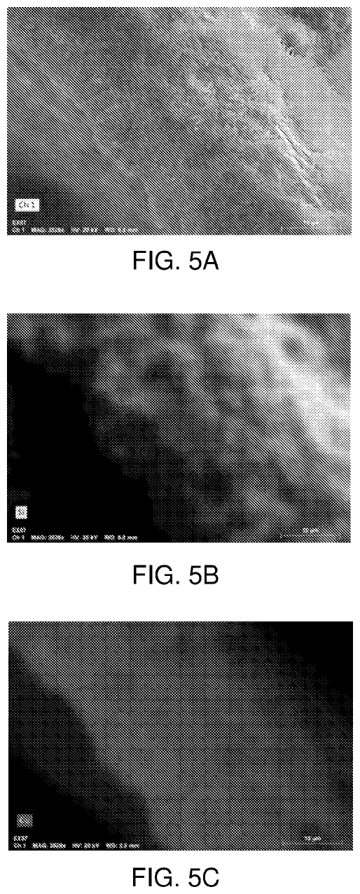

FIG. 5A is an SEM image of an exemplary silicon anode material consisting of silicon nanotubes bonded to copper current collector. FIGS. 5B and 5C are elemental analysis images of the same material from FIG. 5A. FIG. 5B shows only silicon illuminated. FIG. 5C shows only copper illuminated. These images are qualitative evidence of the purity of the sample silicon anode material. Normalized mass percentage measurements of the sample validated that copper and silicon together account for 100% of the sample material (within customary margins of error).

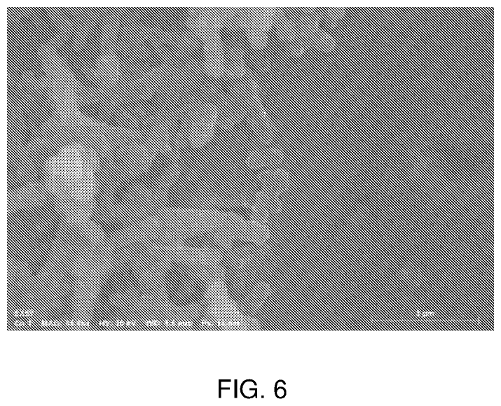

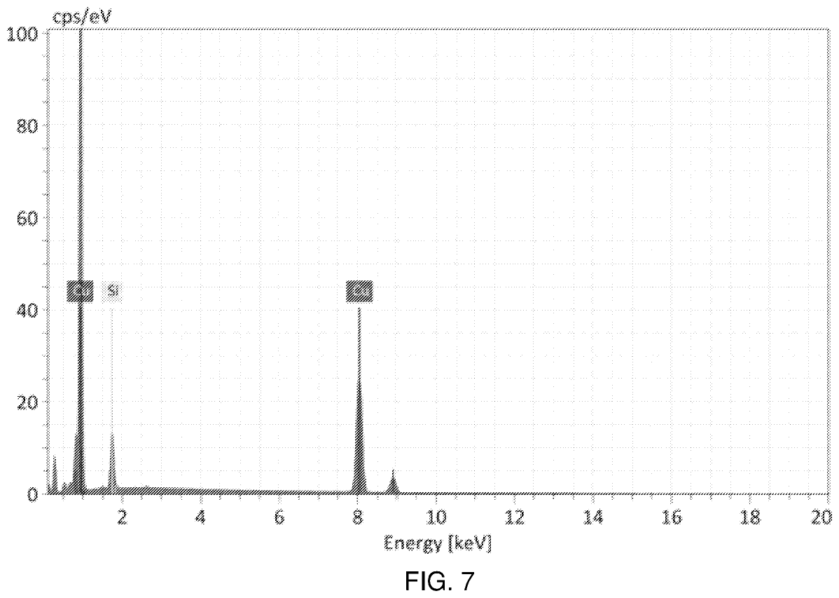

FIG. 6 is an SEM image of a further exemplary silicon anode material consisting of silicon nanotubes bonded to copper current collector. FIG. 7 shows elemental analysis data for the imaged sample. The data demonstrates that copper and silicon together account for 100% of the sample material (within customary margins of error).

Even though a range of crystalline lithium-silicon alloys exist at room temperature, they are not all formed during lithiation and delithiation of the anode. Progressive lithiation of the silicon forms amorphous compounds until it spontaneously experiences an amorphous to crystalline phase transformation when x reaches 3.75 (see Table 2). The phase change is driven by similar electronic structure. Si—Si interactions and weakening of the sp hybrid orbital gradually is what causes the shift.

TABLE 2
Anodic Peaks and Reactions

| | |
|---|---|
| Si →a: LixSi | V = 0.2-0.13 V |
| where 2.1 < x < 3.75 | |
| a: Li_{3.75}Si → c: Li₁₅Si₄ | V = 0.13 V |

Cathodic Peaks and Reactions

| | |
|---|---|
| c: Li₁₅Si₄ → a: Li_{3.75}Si | V = 0.33 V |
| a: Li_{3.75}Si → a: LiₓSi | V = 0.33-0.4 V |
| where 3.5 < x < 3.75 | |
| a: LixSi →Si | V = 0.4-0.47 V |
| where 2.1 < x < 3.5 | |
| a: Li₂Si →Si | V = 0.6 V |

### Example

This example provides empirical results for a sample silicon anode for lithium-ion batteries consisting of a layer of 100% nanotubes directly bonded with copper foil.

Synthesis of silicon nanotube anode material. Silicon nanotube thin films were fabricated using PECVD. Silicon was deposited directly onto a ZnO nanowire substrate directly cast on copper foils and kept at temperatures less than 500° C. A dilute mixture of silane in hydrogen gas (2% SiH₄/H₂) at low pressure (<1 T) was subjected to plasma excitation with <100 W of RF power, which dissociated the silane and made Si:H and Si available to deposit on the substrate. After the silicon layer was able to grow to some thickness, the ZnO cores were removed using HCl vapor, leaving behind pure silicon tubes, well bonded the copper current collector. When subjected to a heat treatment after silicon deposition, a layer of copper silicide formed at the interface between the layer of tubes and the foil.

Crystal structure and morphology characterization. The silicon deposition on copper foils was characterized for phase identification using X-ray diffraction (Bruker D8 Discover) with Cu Kα radiation (λ=1.5418 Å) in the 20 range of 10-80°. Bruker EVA software and ICDD PDF-2 database software were used for phase identification. A field emission scanning electron microscope (FE-SEM) was employed for morphology analysis-FEI Nova model 600. Transmission electron microscopy (TEM) images were taken using an FEI Tecnai F20 microscope. Raman measurements were performed in a backscatter configuration using an in Via Renishaw micro-Raman spectrometer, equipped with a 50× objective lens, visible light optics, a 1200 mm-1 diffraction grating, and a HeNe laser producing 633 nm excitation wavelength.

Cell assembly and electrochemical characterization. For electrochemical testing, half cells were constructed with 2032 coin cells and assembled in an Argon filled glovebox. The working electrode was the copper film with silicon loading in the range of 0.3-1.2 mg·cm⁻² in nanotube structure. The electrolyte used was ethylene carbonate/dimethyl carbonate (EC/DMC) 1:2 with 2% fluoroethylene carbonate (FEC), and Celgard separators provided the barrier against the lithium metal reference electrode.

### Results

SEM imaging showed the process produced an interconnected layer of thin-walled silicon tubes (see FIG. 3A). The porous nature of the layer as well as the open cores provided space for the silicon to expand without pulverizing upon cycling. TEM imaging shows tubes from this sample with wall thicknesses of 5 nm and 20 nm with an open core (See FIG. 3E).

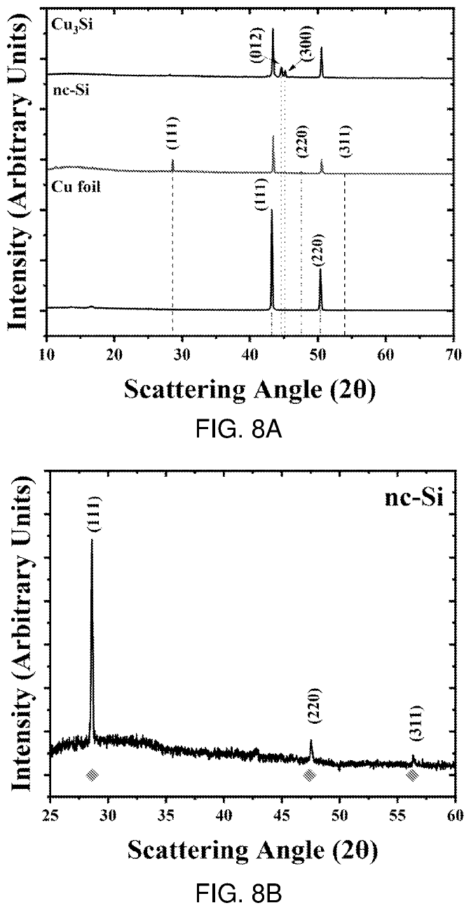

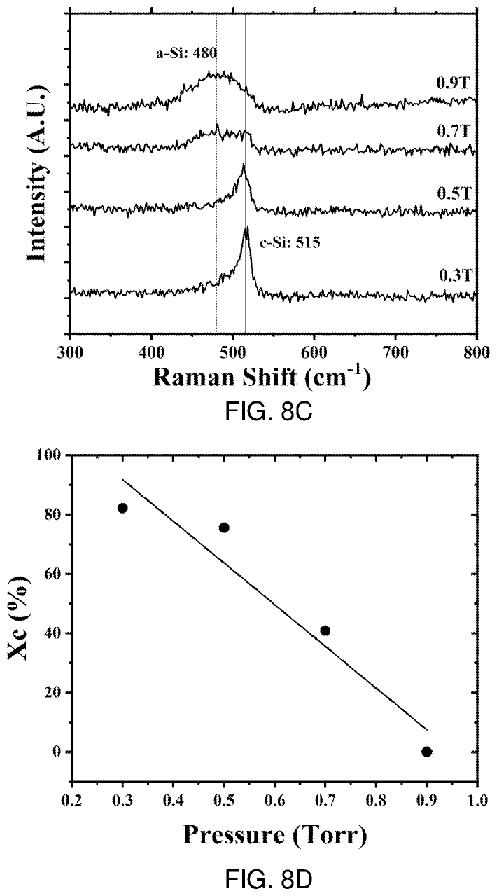

XRD data shows that pure copper metal is present in pristine samples as well as samples with silicon deposition, and even in conditions when copper silicides are formed. FIG. 8A shows XRD scans showing the presence of pristine copper foil, nc-Si formation, and a Cu₃Si layer. The copper foil showed excellent stability. Copper crystal structure was indexed with peaks (111) and (200) at 2θ=43.18° and 50.34°, respectively, in all samples. When silicon was deposited at 0.3 T, both XRD and Raman data confirmed presence of nanocrystalline silicon (nc-Si).

FIG. 8B shows an enlarged view of nanocrystalline silicon (nc-Si) data from FIG. 8A. The relatively small intensity of nanocrystalline peaks are easily identified when the copper peaks are removed from view; planes (111), (220), (311) have formed at 2θ=28.61°, 47.54°, and 56.52°. When subjected to a heat treatment after silicon deposition, a layer of copper silicide formed at the interface between the layer of tubes and the foil. This is visible in Cu₃Si peaks (JCPDS card No. 51-0916) indexed to (300) at 45.0° and (012) at 44.6° (FIG. 8A).

Raman data (FIG. 8C) shows the evolution of silicon from amorphous to crystalline character based upon deposition pressure. A large amorphous silicon peak formed, centered at wavelength 480 cm⁻¹ at pressure closer to 1 T; decreasing pressure forms an increasingly crystalline silicon layer, with peak centered at 515 cm⁻¹. Deconvolution of raman data shows that crystalline and amorphous phases were formed. The % c-Si decreases as pressure increases (FIG. 8D).

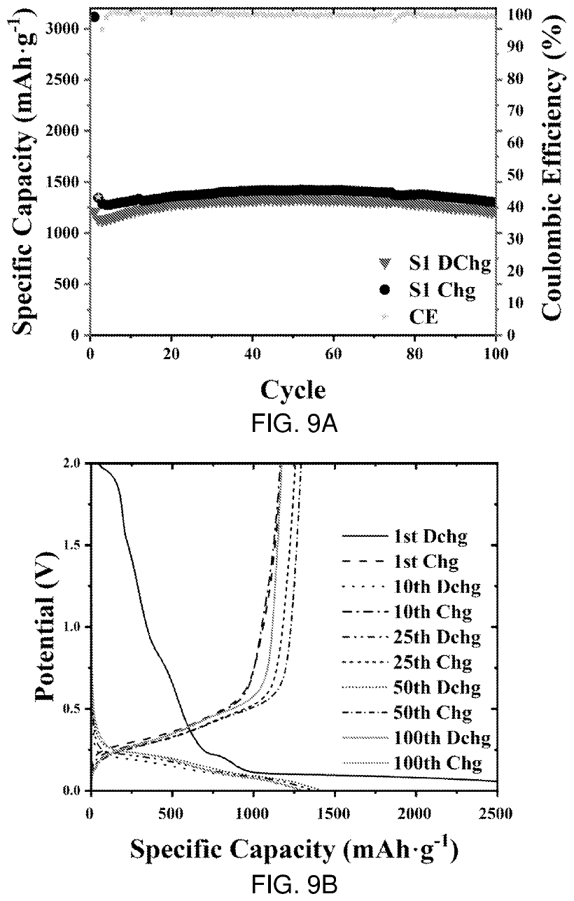

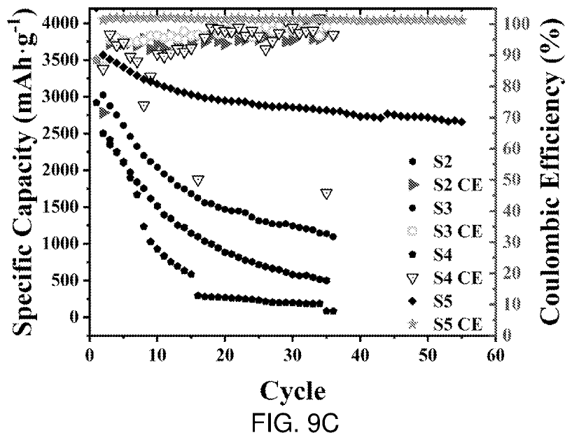

FIG. 9A shows results of cycle performance of anodes loaded with 0.3 mg/cm² silicon, with tubes at wall thicknesses of 5-20 nm. Cells cycled with >99% coulombic efficiency at 100 cycles with reversible capacity of 1250 mAh/g. The first cycle showed significant capacity loss in first cycle of 1750 mAh/g. FIG. 9B shows charge discharge curves remain stable after first irreversible discharge is completed.

The loading was then increased to 0.6 mg/cm² so that performance of tube wall thicknesses could be compared. Anodes at 0.6 mg/cm² silicon loading with nanotube wall thickness of 50-75 nm (“S2”), 100-150 nm (“S3”), and 150-185 nm (“S4”) maintained capacity up to 1000 mAh·g⁻¹ at 35 cycles. Of these three comparative samples, 100-150 nm tubes exhibited the best performance with initial specific capacity of 3080 mAh/g and maintained >1000 mAh/g at 35 cycles. Increasing silicon loading of anode material by increasing the tube wall thickness effectively increased arcal capacity. A final sample with nanotube wall thickness of 100-150 nm and loading of 1 mg/cm² (“S5” in FIG. 9C) exhibited the best performance with areal capacity >2 mAh/cm² at 55 cycles.

Where a range of values is provided in this disclosure, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described.

As used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely”, “only”, and the like in connection with the recitation of claim elements, or use of a “negative” limitation.

As will be apparent to those of skill in the art upon reading this disclosure, each of the individual embodiments described and illustrated herein has discrete components and features which may be separated from or combined with the features of any of the other several embodiments without departing from the scope or spirit of the present invention. Any recited method can be carried out in the order of events recited or in any other order which is logically possible.

While exemplary embodiments of the present invention have been disclosed herein, one skilled in the art will recognize that various changes and modifications may be made without departing from the scope of the invention as defined by the following claims.

What is claimed is:

1. A silicon anode material comprising silicon nanotubes bonded directly to a copper current collector.

2. The silicon anode material of claim 1, wherein the silicon nanotubes are configured to have isotropic expansion.

3. The silicon anode material of claim 2, wherein the silicon nanotubes comprise amorphous state silicon.

4. The silicon anode material of claim 1, wherein the silicon nanotubes have Si loading of at least 1.2 mg·cm⁻².

5. The silicon anode material of claim 1, wherein the silicon nanotubes have an average wall thickness of 5-200 nm without lithiation.

6. The silicon anode material of claim 1, wherein the silicon anode material comprises no more than 10% copper silicide by mass.

7. A lithium-ion battery, comprising
a copper current collector;
an anode comprising a layer of silicon nanotubes bonded directly to the copper current collector;
a cathode; and
a cathode current collector.

8. The lithium-ion battery of claim 7, wherein the silicon nanotubes are configured to have isotropic expansion.

9. The lithium-ion battery of claim 8, wherein the silicon nanotubes comprise amorphous state silicon.

10. The lithium-ion battery of claim 7, wherein the silicon nanotubes have Si loading of at least 1.2 mg·cm⁻².

11. The lithium-ion battery of claim 7, wherein the silicon nanotubes have an average wall thickness of 5-200 nm without lithiation.

12. The lithium-ion battery of claim 7, wherein the silicon anode material comprises no more than 10% copper silicide by mass.

13. A method of synthesizing a silicon anode material, comprising
casting a sacrificial substrate on copper foil;
depositing silicon on the sacrificial substrate and copper foil; and
removing the sacrificial substrate such that a silicon layer remains which is bonded directly to the copper foil.

14. The method of claim 13, wherein the silicon layer comprises silicon nanotubes.

15. The method of claim 13, wherein the depositing step is performed at temperatures not exceeding 500° C. and the removing step is performed at temperatures not exceeding 500° C.

16. The method of claim 13, wherein the step of removing the sacrificial substrate is performed without liquid etchants.

17. The method of claim 13, wherein the step of depositing silicon is by Plasma-Enhanced Chemical Vapor Deposition (PECVD).

18. The method of claim 17, wherein temperature, pressure, and deposition rate of the depositing step are controlled such that deposited silicon is predominantly amorphous state.

19. The method of claim 13, wherein the silicon layer that remains immediately following the removing step is substantially free of copper-silicide.

20. The method of claim 13, further comprising a step of heating treating after the removing step to form a copper silicide interface.
